(19) United States
(12) Patent Application Publication
(10) Pub. No.: US 2017/0016601 A1
(43) Pub. Date: Jan. 19, 2017

(54) Variably Mountable Wall Pack Light

(71) Applicants: Benjamin Pouladian, Commerce, CA (US); Saman Sinal, Commerce, CA (US)

(72) Inventors: Benjamin Pouladian, Commerce, CA (US); Saman Sinal, Commerce, CA (US)

(21) Appl. No.: 14/801,676

(22) Filed: Jul. 16, 2015

(51) Int. Cl. F21V 21/116; F21S 8/04; F21V 23/02; F21S 8/08; F21V 21/14; F21V 15/01; F21S 8/00

(52) U.S. Cl. CPC F21V 21/116; F21V 15/01; F21S 8/043; F21S 8/033; F21S 8/08; F21V 21/14; F21V 23/02; F21W 2131/107

(57) ABSTRACT

A wall pack light and kit for the same are provided which comprise, in part, a housing for containing a light source. The housing may have a first side configured to expose emissions from the light source and a second side formed to define a recessed segment sized to interchangeably receive one or more arms individually configured to securably mount the wall pack light to various supports such as an overhead structure, a wall, or even a pole.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to lighting fixtures and, more particularly, to wall pack lights configured to variably mount to any of an overhead, wall, or pole support or structure.

### BACKGROUND

Various methods and apparatuses for providing outdoor lighting are available in the marketplace. For instance, wall pack lights, or simply wall packs, are widely used as commercial, outdoor lighting fixtures due to their durability and ability to provide efficient lighting over large areas while, in some cases, minimizing undesirable light pollution. Indeed, such lights are even capable of producing illumination through harsh weather conditions including, for example, rain, snow, sleet, and fog.

Still, traditional wall packs available in the marketplace are often configured for mounting only on limited surfaces or structures. This can make wall packs inconvenient and expensive for consumers who must purchase a number of different types of wall packs to light desired surroundings from various supports. For example, some may wish to mount multiple wall pack lights from a wall, from a ceiling or overhang, and even from a pole. Others may wish to ensure that the wall pack lights mounted from such diverse supports maintain a uniform aesthetic. Some may even wish to be able to alternatively mount wall pack lights on such supports.

Some attempts to provide adaptable lighting fixtures for have been made. For example, U.S. Pat. No. 2,858,381 to Goldberg et al. teaches a rail or track to accommodate interchangeable and adjustable lighting fixtures. Although a cord is provided for suspending one of a variety of interchangeable lighting fixtures, such interchangeable lighting fixtures are limited in their placement on or along a supportive surface on account of the fixed track. As another example, U.S. Pat. No. 5,613,766 to Raouf discloses and adjustable luminaire having a reflector, or lighting, housing that is rotatably moveable with respect to a ballast housing. Still, neither reference teaches accommodating any interchangeable arms to mount the housing directly on various supporting surfaces.

Although various proposals have been made to solve the problem, none of those in existence combine the characteristics of the present invention. Therefore, there is a need for a lighting fixture adaptable for mounting on various supports and/or surfaces.

### SUMMARY

The present disclosure is directed to lighting sources, such as wall packs or wall pack lights, adaptable for mounting on variously oriented support structures. For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, the wall pack light comprises a housing for containing a light source. For example, the light source may comprise an electronic or solar powered light-emitting diode (LED). As other examples, the light source may comprise any of a fluorescent, metal halide, high pressure sodium, or even an induction light bulbs. Of course, the light source need not be limited to those listed, and one skilled in the art will recognize that many types of light sources may be used for illumination in a wall pack. Indeed, such lighting sources may be specifically chosen according to the environment surrounding the light. When provided for use in an outdoor wall pack fixture, for example, a lighting source capable of providing illumination through various natural weather conditions such as rain, fog, sleet, or snow may be desirable.

The wall pack light may further comprise a housing having a first side, a second side defining a recessed segment, and an edge extending from the second side to vertically space the first and second sides from one another and further define the housing as a box to contain the light source. More particularly, the first side may be configured to expose emissions from the light source. For example, a translucent face plate, such as one made of glass, may be provided thereon. In some embodiments, the face plate may be smooth to permit a high level of transmittance. In other embodiments, the face plate may be somewhat opaque to decrease the amount of light transmitted from within the housing. In still other embodiments, the face may comprise prismatic lens refractors to diffuse light over more of the surrounding area. Thus, the face plate may comprise any material or texture to achieve a desired level of transmission and/or diffusion into the surrounding area.

The second side of the housing may define a recessed segment to receive an arm for mounting the housing onto a support. In a preferred embodiment, the recessed segment may be formed to securably receive one of a number of interchangeable arms, allowing a user to selectively mount the housing to various surfaces. For example, an arm may be provided to mount the housing to a wall. An arm may be provided to mount the housing to an overhead structure such as a ceiling. An arm may even be provided to mount the housing from a pole. This interchangeability may provide a user with flexibility to provide lighting even if the availability or type of support structures for mounting the housing in the surrounding area are limited.

It is contemplated that the recessed segment may permit receipt of an arm so that, regardless of the support structure contemplated, the first side directs emissions from the light source in a downward direction. Thus, for example, any arm provided for mounting the arm to a wall may be secured to within the recessed segment of the second side of the housing parallel to a plane defined by the first side. A user may thus be assured that emissions from the light source within the housing may be exposed downward from the housing to light any near-ground features in the environment regardless of its mounted placement from a wall or a pole.

Similarly, an arm for mounting the housing to an overhead structure such as a ceiling or canopy may be provided to ensure that emissions from the light source may be exposed downward. For example, such an arm may be secured within the recessed segment of the second side of the housing perpendicular to the plane defined by the first side. Of course the foregoing are offered by way of example only, and not of limitation. One skilled in the art will recognize that the recessed segment in the second side of the wall pack housing, as well as any arms provided, may be variously configured to permit mounting on any number of support structures or surfaces. It is contemplated that the wall pack lighting fixtures may be mounted from homes, apartment buildings, warehouses, office buildings, schools, churches, parking garages, and—where such buildings are not available for mounting—from poles for the purposes of safety, security, and even general visibility. Still, it should be noted that the applicability of the wall pack lights is not limited to such supports listed, but rather may be mounted in or on any areas where a light fixture is desired.

In some embodiments, the first side of the housing may further be removable from its position in relation to the second side. For example, the first side may be hingedly attached to the edge of the housing to permit a user to selectively access the lighting source disposed therein. As another example, it may be latchably coupled to the edge of the housing. This may allow a user to change lighting sources in the event that such lighting sources burn out, or even in the event that a user wishes to change the type of lighting source disposed within the housing.

Additionally, any one or a combination of the first and second sides, and even the edge may be formed to define a heat sink to dissipate heat generated by emissions from the light source. In some embodiments, the housing may further comprise rugged material rated for exposure to moisture and other conditions to which the mounted lighting fixture might be exposed. For example, in outdoor areas exposed to rain and other condensate, one or more gaskets may be provided to seal any gaps between the first side and edge extending from the second side so that the lighting source and any other elements contained within the housing remain dry.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a perspective view of an embodiment of a wall pack light.

FIG. 2 is an alternate perspective view of the embodiment of the wall pack light from FIG. 1.

FIGS. 3 and 4 illustrate the wall pack light of FIG. 1 securably engaging with an arm formed for mounting the light from a ceiling.

FIGS. 5 and 6 illustrate the wall pack light of FIG. 1 securably engaging with an arm formed for mounting the light from a pole.

FIGS. 7 and 8 illustrate the wall pack light of FIG. 1 securably engaging with an arm formed for mounting the light from a wall.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

The terms “first,” “second,” “third,” “fourth,” and the like in the description and in the claims, if any, are used for distinguishing between similar elements and not necessarily for describing a particular placement, or sequential or chronological order. It is to be understood that the terms so used are interchangeable under appropriate circumstances such that the embodiments described herein are, for example, capable of physical arrangement other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such article, device, or apparatus.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

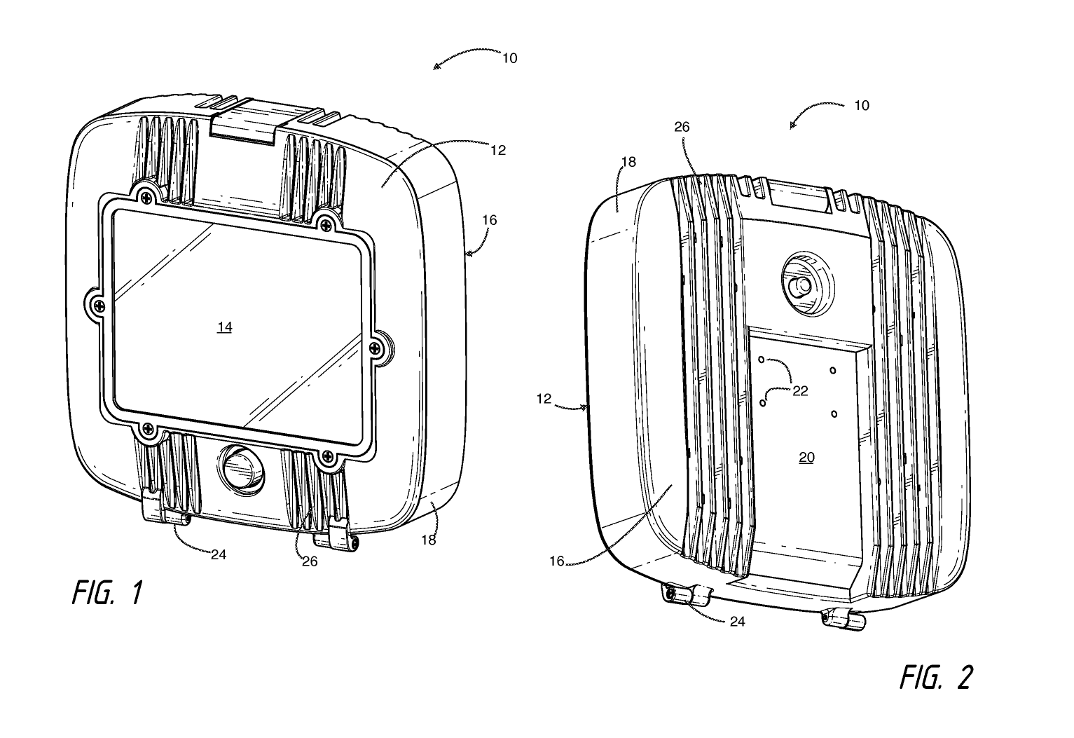

With reference to FIG. 1 a housing 10 is shown that is formed as a box for containing a light source. In an embodiment, the housing 10 may comprise a first side 12 with a face plate and/or glass lens 14 for exposing emissions from the light source, a second side 16, and an edge 18 extending from the second side 16 to provide a physical spacer between the first and second sides 12, 16 so that the lighting source and means for operating the lighting source, such as any sensors, electrical wiring, circuit boards, and even power sources, may also be contained therein. Of course, whether or not any such elements are contained within the housing 10 may depend on the particular needs of the user and type of light source used. For example, in some embodiments, the light source may comprise an electrically powered LED board well known in the art and commonly used for its energy efficiency as well as intensity. Of course, other light sources are available for use in the wall pack light. For example, the light source may comprise any of a fluorescent, metal halide, high pressure sodium, or even an induction light bulbs, or any other type of light source as may be desirable. These may be powered electrically, via solar power, or any other form of power. Thus, the wall pack light should not be limited by the light source or even by the contents in the housing 10. The foregoing are offered by way of illustration only. Additionally, the wall pack light housing 10 need not necessarily take the form of a box as in the exemplary figures provided. In some embodiments, it may be desirable to form the wall pack light housing 10 to cast light in a desired manner. In other embodiments, the form of the wall pack light housing 10 may be chosen to aesthetically coordinate with the environment surrounding the wall pack light.

With particular attention to FIG. 2, the second side 16 may define a recessed segment 20 configured to securably and alternatively receive one of a variety of interchangeable arms for mounting the housing 10 to a supportive structure. Thus it may be seen that a plurality of holes 22 are disposed in the recessed segment 20. Such holes may receive means for coupling any one of the interchangeable arms (discussed in further detail below) to the second side 16 of the housing 10. In some embodiments, the means for coupling may comprise threadbly and releaseably securable screws. In other embodiments, the means for coupling may comprise releasably securable bolts or nails. In still other embodiments, one or more slidably mateable rails may be formed within the recessed segment 20 to mate with portions formed on the interchangeable arms. One skilled in the art will recognize that many methods and means are available to ensure that any of the interchangeable arms may be securely received within the recessed segment 20, and also that any arm secured thereon may be removed in the event that a user wishes to interchange the arm for another of the interchangeable arms.

In some embodiments, the wall pack light housing 10 may be hinged 24 to optionally permit user access to any light source contained therein. This may be particularly desirable where, for example, such a light source have burned out and require replacement. This may also be desirable where, as another example, a user desires to change the type of light source or even replace or repair any sensors, wiring, or power sources also contained therein. For example, certain light sources and bulbs may be better suited to light surroundings in inclement weather, including rain, fog, sleet, or snow. Likewise, the face plate 14 that exposes emissions from the light source contained within the housing 10 may be shaped, textured, or otherwise colored according to a user's particular lighting needs. For example, in some embodiments, the face plate 14 may be smooth to permit a high level of transmittance from the light source. In other embodiments, the face plate 14 may be partially opaque to decrease the amount of light transmitted from within the housing 10. In still other embodiments, the face plate 14 may comprise prismatic lens refractors to diffuse light over more of the surrounding area.

In some embodiments, any, or a combination of, the first and second sides 12, 16 and the edge 18 may be formed to comprise heat sinks 26 which prevent the wall pack light housing 10 from overheating during use.

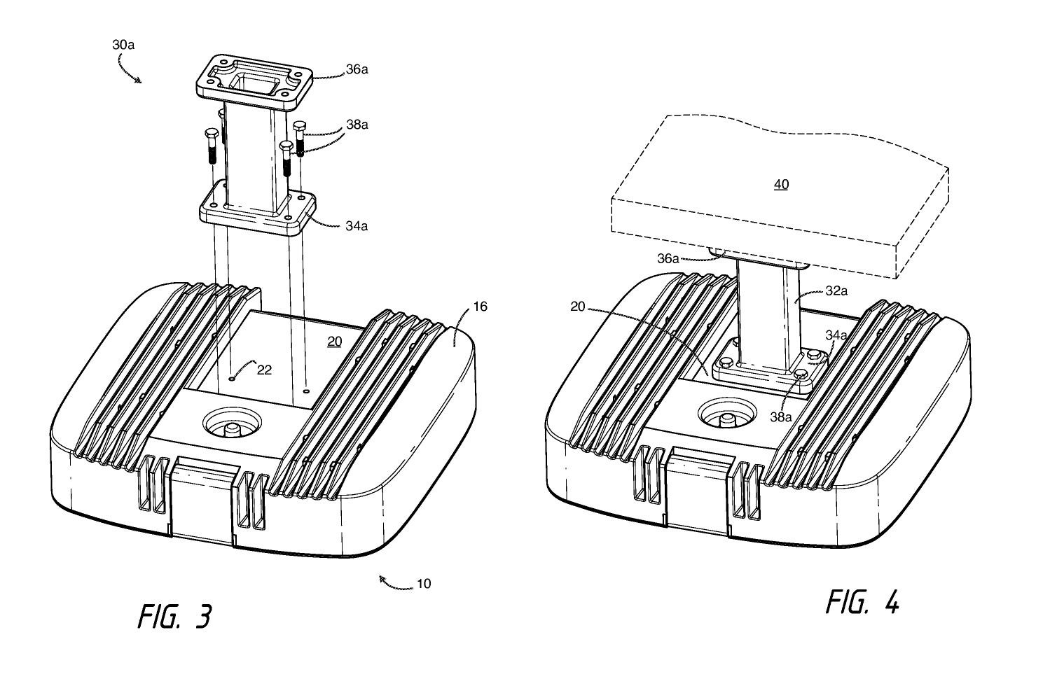

With reference now to FIGS. 3-8, the wall pack light housing 10 is shown securably coupling to various embodiments of the interchangeable arm so that the wall pack light may be mounted to a variety of supportive structures. In FIGS. 3-4, for example, an interchangeable arm 30a is provided to mount the housing 10 from an overhead surface 40. The overhead surface 40 may be a structure such a ceiling, canopy, prop, brace, or stay. The arm 30a may comprise an elongate, rigid body 32a having a housing-side end 34a and a structure-side end 36a. Such ends may be formed as flanges surrounding the rigid body 32a and may define holes for receiving means for coupling 38a the arm 30a to the housing 10 via the holes 22 defined in the recessed segment 20 of the second side 16 of the housing 10. Means may also be provided for joining the coupled housing 10 and arm to a support such as a ceiling 40.

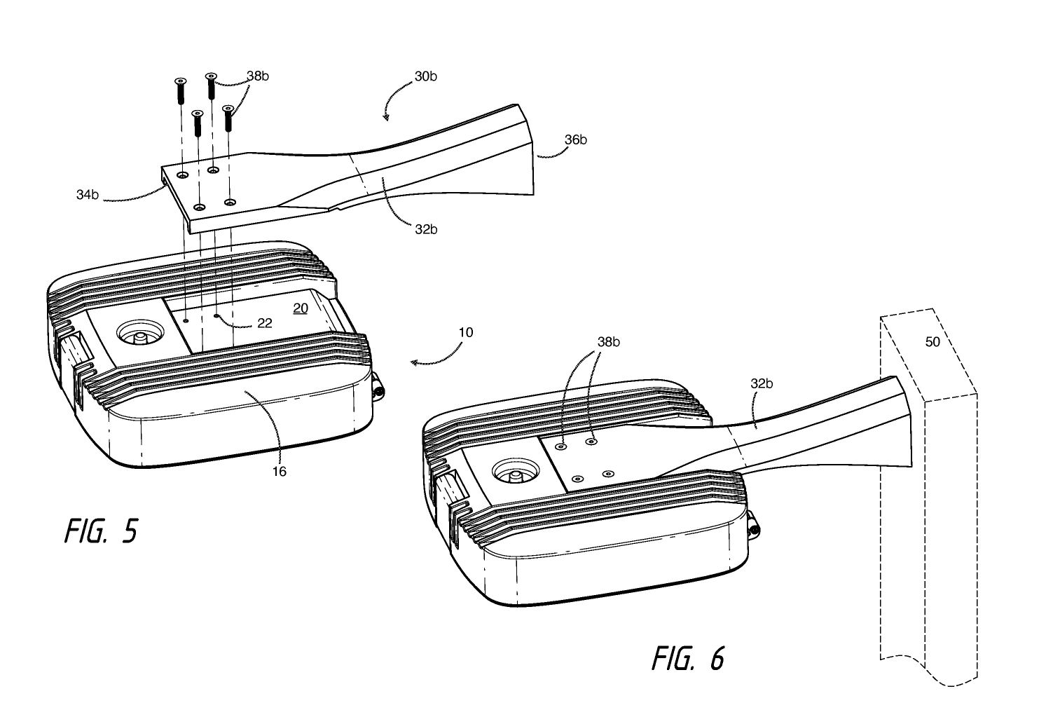

With reference now to FIGS. 5 and 6, the wall pack light housing 10 is shown alternatively coupling to another interchangeable arm 30b configured to mount the wall pack light from a pole 50. In an embodiment, the interchangeable arm 30b may comprise an elongate, rigid body 32b, having a broad support or structure-side end 36b to withstand the weight of the housing 10 in its extended position away from the pole 50. The interchangeable arm 30b may further comprise a tapered housing-side end 34b. The arm 30b is shown in the images as having an angularly rounded design, however, one skilled in the art will recognize that such a design may be altered depending on the particular aesthetic desired by a user or even various physical force requirements. Furthermore, the pole 50 defining the structure to support the wall pack light need not conform to the shape illustrated as the illustration is provided by way of example only and not of limitation.

Similar to the interchangeable arm 30a in FIGS. 3 and 4, the tapered, housing-side end 34b of the exemplary arm 30b illustrated in FIGS. 5 and 6 may define holes for receiving means for coupling 38b the arm 30b to the housing 10 via the holes 22 defined in the recessed segment 20 of the second side 16 of the housing 10. Likewise, means may also be provided for joining the coupled housing 10 and arm to a support such as the pole 50.

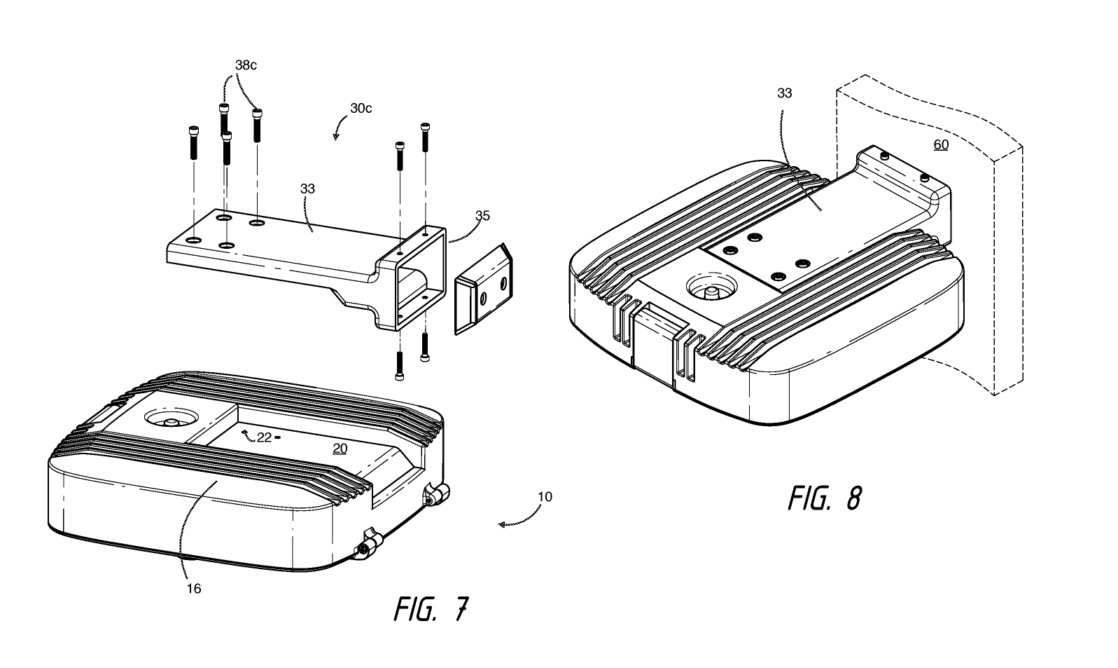

With reference now to FIGS. 7 and 8, the wall pack light housing 10 is shown alternatively coupling to still another interchangeable arm 30c configured to mount the wall pack light to a wall 60 or other vertically oriented structure or support. In an embodiment, the interchangeable arm 30c may comprise an elongate, rigid body having a flat portion 33 formed for receipt by the recessed segment 20, and a mounting portion for joining the wall pack light housing 10 to the wall 60. Similar to the aforementioned interchangeable arms 30a, 30b, the flat portion 33 of the arm 30c may define holes for receiving means for coupling 38c the arm 30c to the housing 10 via the holes 22 defined in the recessed segment 20 of the second side 16 of the housing 10. Likewise, means for joining 35 the coupled housing 10 and arm 30c to a support such as the wall 60.

It may be noted with reference to FIGS. 3-8 that the wall pack light housing 10 may be configured so that the first side faces in the same downward direction when an appropriate interchangeable arm is selected to mount the housing 10 to each respective supportive surface.

It is contemplated that the housing 10, one or more interchangeable arms, and means for coupling the same may be provided as elements in a kit. Additional elements such as a light sources, power sources, sensors, and gaskets may further comprise the kit.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) or potentially are equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the housing may comprise a various materials chosen according to the particular needs of the user. As another example, the face plate or lens revealing the light source within the housing may be textured or even comprise other materials Accordingly, it is intended that the invention not be limited, except as by the appended claim(s).

The teachings disclosed herein may be applied to other systems, kits, or apparatuses, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the interchangeable mounts for wall pack lights with which that terminology is associated. In general, the terms used in the following claims should not be constructed to limit the interchangeable mounts for wall pack lights to the specific embodiments disclosed in the specification unless the above description section explicitly define such terms. Accordingly, the actual scope encompasses not only the disclosed embodiments, but also all equivalent ways of practicing or implementing the disclosed apparatus. The above description of embodiments of the interchangeable mounts for wall pack lights is not intended to be exhaustive or limited to the precise form disclosed above or to a particular field of usage.

While specific embodiments of, and examples for, the apparatus are described above for illustrative purposes, various equivalent modifications are possible for which those skilled in the relevant art will recognize.

While certain aspects of the apparatus disclosed are presented below in particular claim forms, various aspects of the apparatus are contemplated in any number of claim forms. Thus, the inventor reserves the right to add additional claims after filing the application and to pursue such additional claim forms for other aspects of the interchangeable mounts for wall pack lights.

What is claimed is:

1. A wall pack light, comprising:
a light source; and
a housing to contain the light source, the housing having a first side to expose emissions from the light source, and a second side defining a recessed segment to securably receive one of one or more interchangeable arms for optionally mounting the housing on various supports.

2. The wall pack light according to claim 1, wherein one interchangeable arms is configured to optionally mount the housing to an overhead structure.

3. The wall pack light according to claim 1, wherein one of the interchangeable arms is configured to optionally mount the housing to a wall.

4. The wall pack light according to claim 1, wherein one of the one or more arms is configured to optionally mount the housing from a pole.

5. The wall pack light according to claim 1, wherein the one or more arms may be optionally configured so that when secured to the housing and mounted to a support, the first side of the housing exposes the light source in a downward direction.

6. A kit for a wall pack lighting fixture, comprising:
a light source;
a housing for containing the light source, the housing having a first side to expose emissions from the light source, and a second side defining a recessed segment; and
at least two interchangeable arms for optionally mounting the housing on various supports;
wherein the recessed segment is sized to securably receive any of the said interchangeable arms.

7. The kit of claim 6, further comprising a plurality of members to securably join any of said interchangeable arms within the recessed segment of the housing.

8. The kit of claim 7, further comprising a plurality of members to removably fix any of said interchangeable arms securably joined within the recessed segment of the housing to a support.

9. The kit of claim 6, wherein said interchangeable arms are configured to optionally mount the wall pack light on an overhead surface.

10. The kit of claim 6, wherein said interchangeable arms are configured to optionally mount the wall pack light on a wall.

11. The kit of claim 6, wherein said interchangeable arms are configured to optionally mount the wall pack light so that it extends from a pole.

12. The kit of claim 6, further comprising means for coupling the light source to a power source.
